(19) United States
(12) Patent Application Publication
(10) Pub. No.: US 2018/0085844 A1
(43) Pub. Date: Mar. 29, 2018

(54) Diamond spot welding head

(71) Applicant: Jinshui Zhang, Jiujiang (CN)

(72) Inventor: Jinshui Zhang, Jiujiang (CN)

(21) Appl. No.: 15/276,989

(22) Filed: Sep. 27, 2016

(51) Int. Cl. B23K 11/11; C01B 31/06

(52) U.S. Cl. CPC B23K 11/11; C01P 2006/80; C01B 31/06

(57) ABSTRACT

The invention discloses a diamond spot welding head, spot welding head at the front end of the diamond material is increased, the quality of the diamond material in accordance with the percentage composition comprises: C 98%-99.9%, impurity components 0.1-4%, wherein the impurities groups Inclusions Si, Al, Ca, Mg, Mn, Ti, Cr, N. The invention provides a diamond spot welding head, so that the welding head welding contact surface hardness, heat performance, heat resistance, etc. greatly increased. Greatly increasing the life of spot welding head, thus saving manpower, material cost of the user. It applies to all types of resistance welding process and the welding process in a variety of electronic components.

### TECHNICAL FIELD

The invention relates to field of welding equipment, concrete is a kind of diamond spot welding head.

### BACKGROUND TECHNIQUE

Production process of electronic components, often need welding wire in the winding device by welding or soldering equipment to complete the job in the process, spot welding head is an indispensable tool; in the head by spot welding joints of electronic components together during spot welding head heating power and connected to the electronic components were pressured to complete the welding.

As a consumable welding, spot welding head welding hardness properties of the contact surface, heat performance, heat resistance spot welding head for life will have an important impact, namely surface hardness properties of the weld spot welding head, heat resistance, temperature properties become an important measure of the quality of spot welding head. However, the existing prevailing spot welding head is not high hardness, heat performance in general, poor heat resistance, and short life defects, spot welding head after a long period can cause oxidative shape and appearance changes, the impact of spot welding firmness and appearance of solder joints.

### SUMMARY OF THE INVENTION

Object of the invention is to provide a hardness properties, heat performance, heat resistance and so greatly increase the diamond spot welding head, in order to solve the above problems in the background art presented.

To achieve the above object the present invention provides the following technical solutions:

A line of diamond head spot welding, spot welding head at the front end of the diamond material increases, the quality of the diamond material in accordance with the percentage composition comprises: C 98%-99.9%, impurity components 0.1-4%, wherein the impurity component comprises Si, Al, Ca, Mg, Mn, Ti, Cr, N.

Traditional tungsten steel spot welding head drawback is not high hardness, wear resistance and easy oxidation. The present invention employs the above process to make high hardness, wear good thermal conductivity, hard oxidation. Specific basic role of each component are as follows:

Si: (1) adding silicon in the steel making process as a reducing agent and deoxidizer. (2) silicon can significantly improve the elastic limit of the diamond material, yield point and tensile strength.

N: Nitrogen can improve the strength of diamond material, low temperature toughness and voidability, increasing aging sensitivity, thereby reducing the adverse effects of the addition of Ca element.

Ti: Ti pro since the atoms with oxygen and magnesium can be lower than with oxygen affinities, gathered at the surface of the liquid, priority will combine with oxygen to produce a dense mixed oxide of these elements titanium and diamond material, to prevent diamond material combustion oxidation.

Al in moist air to form an oxide film layer to prevent metal corrosion.

Mg malleable non-magnetic, and has good thermal conductivity.

Mn easily oxidized in air to produce brown oxide coating. It is also easy to oxidation at elevated temperatures. Layered oxide oxidation formed rust leather, metal oxide layer is closest to MnO, while the outer layer is Mn3O4. Oxidation at a temperature higher than 800 deg. C., a gradual increase in the thickness of MnO, Mn3O4 and the thickness of the layer is reduced. Emergence of a third oxide Mn2O2 at 800 degrees. Below about 450° C. outermost fourth layer of oxide MnO2 it is stable. Can decompose in water, soluble in dilute acid, and hydrogen is released to form a divalent manganese ions.

Cr has high corrosion resistance in the air, even under the red hot state, the oxidation is very slow. Insoluble in water. Plating on the metal may play a protective role.

Compared with the prior art, the beneficial effects of the present invention are:

The invention provides a diamond head spot welding, spot welding so that the weld head contact surface hardness properties, heat performance, heat resistance, resistance to oxidation and so greatly increased. Greatly increasing the life of spot welding head, thus saving manpower, material cost of the user. It applies to all types of resistance welding process and the welding process in a variety of electronic components.

### DETAILED DESCRIPTION

Below in connection with embodiments of the invention, the present invention will be apparent case of technical implementation of the program, fully described, it is clear that the described embodiments are merely part of the embodiments of the present invention, but not all embodiments. Based on the embodiments of the present invention, all other embodiments of the ordinary skill in the creative work did not make the premise obtained, are within the scope of the present invention is protected.

### Example 1

Embodiment of the invention, a diamond head spot welding, spot welding head at the front end of the diamond material increases, the quality of the diamond material in accordance with the percentage composition comprises: C 99.9%, 0.1 impurity components, wherein the impurity component comprises Si, Al, Ca, Mg, Mn, Ti, Cr, N and the like.

### Example 2

Embodiment of the invention, a diamond head spot welding, spot welding head at the front end of the diamond material increases, the quality of the diamond material in accordance with the percentage composition comprises: C 98%, 2% impurity components, wherein the impurity component comprises Si, Al, Ca, Mg, Mn, Ti, Cr, N.

### Example 3

Embodiments of the present invention, spot welding head at the front end of the original diamond material is increased, as a main component of the diamond material: carbon (C), C content 98%, impurity components 4%, impurity components have Si, Ai, Ca, Mg, Mn, Ti, Cr, N and the like. Specific size can he customized according to customer requirements and machine products.

The preparation process as described below.

1) Prepare materials: spot welding head substrate and the diamond material.

2) spot welding head substrate material and rough diamond material.

3) The synthesis process of spot welding head base material and the diamond material.

4) Synthesis of precision machining.

5) Formed products.

Use of the invention; 1) welding wire. 2) winding machine accessories. 3) a variety of automation equipment parts.

Because in all elemental, the highest melting point of diamond, up to 3823K. Diamond crystal belongs to the cubic crystal system, is typical of atomic crystals, each carbon atom to sp3 hybrid orbital and the other four carbon atoms form a covalent bond to form a regular tetrahedron. This diamond is face-centered cubic lattice structure. Because diamond crystal C-C bonds are strong, all the valence electrons are involved in the formation of a covalent bond, no free electrons in the crystal, so that not only the hardness of diamond, high melting point, and non-conductive. The present invention will be applied In the diamond spot welding head, thus greatly improving the performance of welded contact surface hardness, heat resistance, wear resistance, resistance to oxidation, etc., increasing the life of spot welding head, saving the user's human and material resources cost.

The present Invention applies to all types of resistance welding processes, such as welding of electronic components, wire welding, PCB circuit boards, used in headphones, a microphone, speakers, buzzers and other audio components of the terminal as well as welding wire audio plug connector welding. Also used in the welding process in a variety of electronic components, such as: SMD Chip inductors welding, SMD patch welding transformers, relays and other welding applications in various connectors of welding, such as USB connectors welding, MIU, USB data cord and other welding processes.

For skilled in the art, the present invention is clearly not limited to the details of an exemplary embodiment, but without departing from the spirit or essential characteristics of the present invention, the invention can be implemented in other specific forms. Therefore, no matter from what point of view, should be seen as an exemplary embodiment, but not limiting, the scope of the present invention is defined by the appended claims rather than the foregoing description define, and therefore intended to fall claim All changes which come within the meaning and range of equivalents of the elements to include in the present invention.

Further, it should be understood that although the present specification are described in accordance with the embodiment, but not every embodiment contains only a separate aspect, this narrative description only for the sake of clarity, those skilled in the specification as a whole should be, in the case of the embodiments of technical solutions to be suitably combined to form other embodiments of skill in the art can understand.

I claim:

1. A diamond spot welding head, wherein, diamond material is added in the front end of the spot welding head, and;
the said diamond material according to the component and mass percent comprises: C 98%-99.9%, and impurity component 0.1-4%;
the said impurity component comprises Si, Al, Ca, Mg, Mn, Ti, Cr, N.
